(19) United States
(12) Patent Application Publication
(10) Pub. No.: US 2001/0020557 A1
(43) Pub. Date: Sep. 13, 2001

(54) Method and hydraulic steering arrangement for emergency steering with a steering handwheel

(76) Inventors: Svend Giversen, Sonderborg (DK); Johan van Beek, Sonderborg (DK); Lars Mortensen, Augustenborg (DK); Ole Vincentz Sorensen, Nordborg (DK)

Correspondence Address: William M. Lee, Jr., Lee, Mann, Smith, MeWilliams,, Sweeney & Ohison, P.O. Box 2786, Chicago, IL, 60690-2786, US

(21) Appl. No.: 09/795,638

(22) Filed: Feb. 28, 2001

(30) Foreign Application Priority Data
Mar. 7, 2000 (DE) 100 11 016.9

(51) Int. Cl. B62D 5/06

(52) U.S. Cl. 180/417

(57) ABSTRACT

The invention concerns a method for emergency steering of a hydraulic steering arrangement (1) with a steering handwheel (2), in which a steering valve (5) is optionally operated via the steering handwheel (2) or via a control pressure generator (7), and a steering motor (4) is acted upon by a pump pressure of a pump (6) via the steering valve (5), as well as a hydraulic steering unit (3) for applying the method.

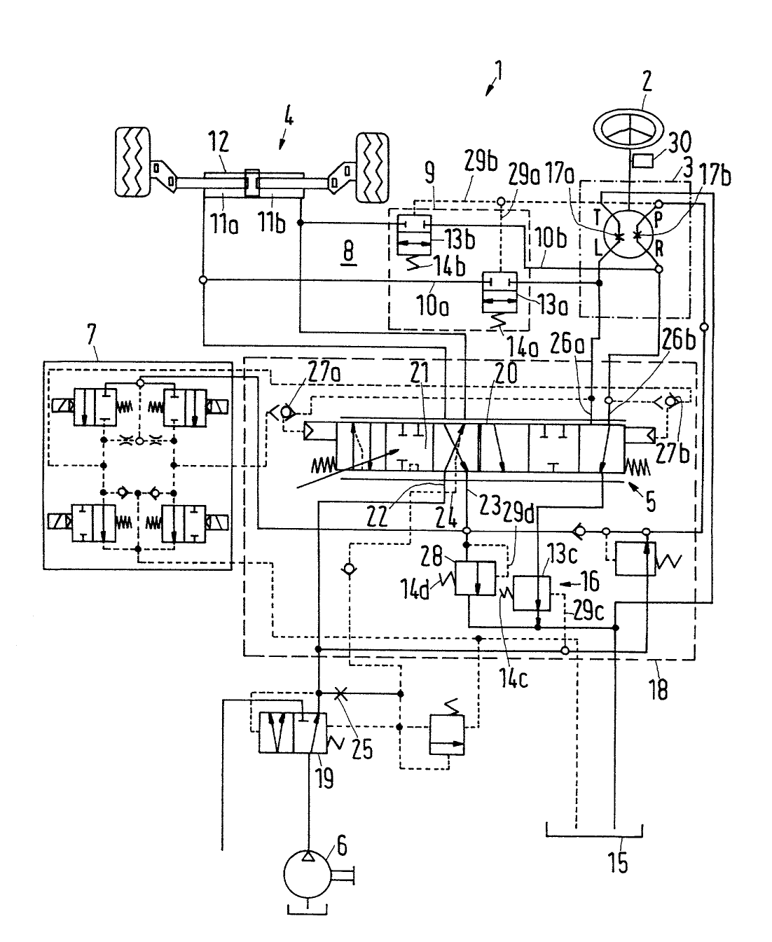

In connection with such a method, it is endeavoured to improve the steering comfort of an emergency steering.

For this purpose, the steering motor (4) is connected with the hydraulic steering unit (3) via an emergency steering path (8), when the pump pressure drops below a first threshold value.

The invention concerns a method for emergency steering of a hydraulic steering arrangement with a steering handwheel, in which a steering valve is optionally operated via the steering handwheel or via a control pressure generator, and a steering motor is acted upon by a pump pressure of a pump via the steering valve, as well as a hydraulic steering unit for applying the method.

A steering arrangement of this kind is known from the post-published German patent application 199 31 143.9, in which a slide of the steering valve can be displaced either by pressures produced by the steering handwheel or by pressures produced by a control pressure generator. Additionally, this steering arrangement has a supply line between the steering unit and the pump. Thus, it is ensured that an activation of the hydraulic steering unit at normal pump operation will cause that pressure fluid will be available in the required quantity and with the required pressure to displace the slide of the steering valve. When the pump fails, the steering motor will be acted upon by a pressure, which is produced by the hydraulic steering unit itself, for example by means of a measuring motor then working as a pump. In this connection, the pressure fluid must then, with corresponding pressure losses, displace the slide of the steering valve, divert a shuttle valve and pass the steering valve twice.

The invention is based on the task of improving the steering comfort in connection with an emergency steering.

With a method as mentioned in the introduction, this task is solved in that the steering motor is connected with a hydraulic steering unit via an emergency steering path, when the pump pressure drops below a first threshold value.

Thus, the flow path of the pressure fluid can be substantially reduced in connection with a pump pressure drop, which causes reduced pressure losses. In this way the remaining pressure is better utilised in the case of an emergency steering, which causes both a reduced reaction time and improved safety. The vehicle is more easily steered by the driver in the case of an emergency steering. Here, it should be mentioned that the term “pump pressure” does not only cover the pressure, which occurs on the physical outlet of a pump. It can also cover the pressure of a unit connected or arranged downstream, for example the outlet of a priority valve, which again may comprise a pressure control valve.

It is advantageous that a pressure relief connection coming from the hydraulic steering unit is blocked when the pump pressure drops below a second predetermined threshold value. This blocking of the pressure relief ensures that the pressure acting upon the steering motor in connection with an emergency steering is kept as high as possible. Thus, again, the reaction time is kept short, which increases the safety of the steering unit.

To realise the method mentioned above, a hydraulic steering unit is provided, in which an emergency steering path with a control unit is arranged between the steering motor and the hydraulic steering unit, the emergency steering path being operable via a pump connection of the hydraulic steering unit. This provides an additional connection between the hydraulic steering unit and the steering motor, via which the steering motor can be acted upon by pressure in dependence of the pump pressure ruling at the pump connection P. According to the available pressure, two different connections are thus available between the hydraulic steering unit and the steering motor, causing that in certain emergency situations the steering motor can be acted upon by pressure direct from the hydraulic steering unit.

Advantageously, the emergency steering path has two short-circuiting connection lines, that is, one between each of the working connections of the hydraulic steering unit and a cylinder side of a steering cylinder of the steering motor. In connection with an emergency steering the flow paths of the pressure fluid are heavily reduced by the short-circuiting connection lines, and additionally several valves are bypassed. Accordingly, the pressure losses caused by wall friction, entry into and outflow from valves and the operation of the valves are heavily reduced. Thus, the pressure available for an emergency steering is utilised better.

Additionally, it is favourable that the control unit has a two/two-way valve in each short-circuiting connection line. The simple embodiment of the two/two-way valves ensures a high operation reliability during opening and closing of the emergency steering path.

It is advantageous that the two/two-way valves of the short-circuiting connection lines are penetrable, when a pump pressure of the pump, which acts upon the two two/two-way valves via the pump connection as adjustment pressure, drops below a predetermined first threshold value. Thus, a pressure intensity of the pump pressure can be determined, below which it is favourable for the emergency steering to occur automatically via the shortened connection between the steering motor and the hydraulic steering unit.

A further embodiment ensures that in connection with steering during normal operation the pump connection has a pressure relief connection to a pressure sink. Through the pressure relief connection excess pressure, which may occur at the hydraulic steering unit during normal operation, can be avoided. Thus, the pressure required for the control of the direction slide of the hydraulic steering unit, is not higher than required.

Preferably, the pressure relief connection has a control element, which can be activated by the pump pressure. The control element ensures that, in dependence of the pump pressure, a pressure relief of the hydraulic steering unit via the pressure relief connection does or does not occur. Thus, in connection with high pump pressures, a possible damaging overpressure at the hydraulic steering unit can be avoided, whereas at low pressures a pressure available at the hydraulic steering unit for acting upon the steering motor is kept as high as possible.

It is favourable that the control element has a two/two-way valve. With its simple design, the two/two-way valve ensures a high operation reliability for the control of the pressure relief connection.

Further, it is favourable that the two/two-way valve of the pressure relief connection is blocked, when the pump pressure of the pump, which acts upon the two/two-way valve as adjustment pressure, drops below a predetermined second threshold value. Thus, a pressure intensity of the pump pressure can be determined, below which it is favourable that the pressure relief of the hydraulic steering unit is automatically disconnected.

It is advantageous that each of the two/two-way valves has a spring with a predetermined spring force, which counteracts the actual adjustment pressure. Thus, in a reliable way, the pressure intensities can be determined, at which the two/two-way valves should be shifted (switched over?).

It is favourable that the two predetermined threshold values are approximately equally high. Thus, in case of a pressure drop of the pump pressure, the short-circuiting connection lines are opened at the same time as the relief connection from the hydraulic steering unit to the pressure sink is closed. Thus, it is ensured that when the pressure drops below the total threshold value, the steering motor can immediately be acted upon by the highest possible pressure for the emergency control.

In the following, the invention is described on the basis of a preferred embodiment in connection with the drawing, showing:

Only Fig. a schematic view of a hydraulic steering unit

A hydraulic steering arrangement 1 has a steering handwheel 2, which is connected with a hydraulic steering unit 3. The hydraulic steering unit 3 is a traditional steering unit with two mutually rotatable slides. The steering handwheel 2 rotates one of the two slides, thus releasing a path from a pump connection P to one of the working connections L, R. whereas the other working connection R, L is connected with a tank connection T. The passing of the hydraulic fluid activates a measuring motor, not shown in detail, but known per se, which accordingly makes the second slide overlap the first slide, to interrupt the flow of the hydraulic fluid again, in dependence of the movement of the steering handwheel 2. The measuring motor can also be used as auxiliary pump, so that an operation of the steering handwheel 2 will cause the production of a hydraulic pressure at one of the two working connections L, R. Throttles 17a, 17b are connected in series with the working connections L, R, respectively.

The hydraulic steering arrangement 1 additionally has a valve block 18 with a steering valve 5. The outlet of the valve block 18 is connected with a steering motor 4, which deflects steered wheels of a vehicle (not shown in detail). For this purpose, the valve block 18 has connections, which are connected with corresponding cylinder sides 11a, 11b of the steering cylinder 12 of the steering motor 4.

Flanged onto the valve block 18 is a control pressure generator 7, producing hydraulic pressures, which can be used for the operation of the steering valve 5 (to be explained in detail below).

The valve block 18 is connected with a pump 6 via a priority valve 19. An additional connection exists between the valve block 18 and a pressure sink 15. In stead of the shown pump 6, another pressure source can be used.

The priority valve 19 is known per se. It ensures that the hydraulic steering arrangement 1 is preferably supplied with pump pressure, also when other consumers are connected.

The steering valve S has a slide 20, which is shown in the working position.

The slide 20 has a first section 21, which is responsible for a connection between the steering motor 4 and the pump 6. For this purpose, a first connection 22 is provided. When the slide 20 is moved to the right, the first connection 22 is connected with the cylinder side 11a. The cylinder side 11b is connected with a second connection 23, through which the returning hydraulic fluid can reach the pressure sink 15, as explained in detail below. At the same time, an LS-connection 24 is supplied with the load pressure from the steering motor 4. Thus, the LS-connection 24 always carries the highest pressure appearing in the system. In the neutral position of the slide 20, the LS-connection 24 is connected with the outlet of the priority valve 19 via a throttle 25. The throttle 25 prevents a larger volume flow through the LS-line.

When the slide 20 is displaced as shown to the left, the other cylinder side 11b is supplied with pressure accordingly, and the wheels are deflected in the other direction.

The displacement of the slide 20 occurs under the influence of hydraulic pressures. The springs, having no specific reference numbers, merely serve the purpose of retaining the slide 20 in its neutral position.

The hydraulic pressures, which are used for the operation of the steering valve 5, can be produced in two different ways. Firstly, the hydraulic pressures are produced by the control pressure generator 7 and led to the front sides of the slide 20 through shuttle valves 27a, 27b. However, the hydraulic pressures can also be produced by an operation of the hydraulic steering unit 3. The other inlets of the shuttle valves 27a, 27b are namely connected with the inlets 26a, 26b of the steering valve 5. The shuttle valves 27a, 27b pass on the higher of the two pressures from the control pressure generator 7 or the hydraulic steering unit 3, respectively, to the front sides of the slide 20 of the steering valve 5. As it is guaranteed that the pressures produced by the control pressure generator 7 are always lower than the pressures produced by the hydraulic steering unit 3, it is ensured that with the steering handwheel 2 the steering behaviour of the vehicle can always be affected, no matter which control pressures the control pressure generator 7 produces. The control pressure generator 7, the shuttle valves 27a, 27b and the control surface of the slide 20 only have a limited pressure stability.

Also when the control pressure generator 7 fails, the slide 20 of the steering valve 5 can be displaced. In this case, the control pressure of the control pressure generator 7 is equal to zero, so that the shuttle valves 27a, 27b pass on the inevitably higher pressure of the hydraulic steering unit 3 to the front sides of the slide 20, thus displacing the slide.

Via an adjustment valve 28, the connection 23 is connected with the pressure sink 15. In the closing direction the adjustment valve 28 is acted upon by a spring 14d and in the opening direction via a control pressure line 29d. When the control pressure of the control pressure line 29d is higher than the force of the spring 14d, the adjustment valve 28 opens, and the excess pressure can flow off to the pressure sink 15.

When, as shown, the slide 20 is displaced into one of its working positions, the connection between the LS-connection 24 and the second connection 23 is interrupted. Then, the pressure of the fluid flowing back from the steering motor 4 is ruling in the second connection 23. When this pressure exceeds the power of the spring 14d, the adjustment valve 28 opens, and the fluid can flow off to the pressure sink 15.

On the steering handwheel 2 a sensor 30 is arranged, which, in a manner not shown in detail, is connected with the control pressure generator 7. By means of the sensor 30, for example the angle position of the steering handwheel 2 can be determined, the control pressure generator 7 producing by means of this information, using predetermined algorithms, the corresponding control pressures according to size and time for the displacement of the slide 20.

Until now, both embodiment and mode of functioning substantially correspond to those described in the German patent application 199 31 143.9.

Additionally, the hydraulic steering arrangement 1 has an emergency steering path 8 with a control unit 9. The control unit 9 has two short-circuiting connection lines 10a, 10b, which are arranged between the two working connections L, R of the hydraulic steering unit 3 and the two cylinder sides 11a, 11b of the steering cylinder 12 of the steering motor 4. The control unit 9 has two two/two-way valves 13a, 13b, each being arranged in one of the two short-circuiting connection lines 10a, 10b. Each of the two two/two-way valves 13a, 13b is connected with the pump connection P of the hydraulic steering unit 3 via a control pressure line 29a, 29b.

During normal operation, the pump connection P, which is connected with the pump 6, is acted upon by a sufficient pump pressure, so that it acts upon the two two/two-way valves 13a, 13b via the control pressure line 29a, 29b with an adjustment pressure, which is sufficient to connect the two two/two-way valves 13a, 13b against the spring force of the springs 14a, 14b, in such a way that the connection between the hydraulic steering unit 3 and the steering motor 4 is blocked via the short-circuiting connection lines 10a, 10b.

If, however, the pump 6 cannot supply a sufficient pump pressure, the two/two-way valves 13a, 13b are only acted upon via the pump connection P by a low pressure to be used as adjustment pressure. If the spring force of the springs 14a, 14b is higher than the counteracting adjustment pressure, the two two/two-way valves 13a, 13b open. When the steering handwheel 2 is operated, the steering motor 4 is now acted upon with pressure direct from the working connection L, R of the hydraulic steering unit 3 via the emergency steering path 8. The pressure is, for example, produced by the measuring motor, and is passed on to the steering motor 4 without large detours.

Further, the steering valve 5 has two inlets 26a, 26b, which are connected with the corresponding working connections L, R of the hydraulic steering unit. When the slide 20 is displaced to the right, the inlet 26a is connected with a control element 16. When the slide 20 is displaced in the other direction, the inlet 26b is connected with the control element 16. Further on in the process, the control element 16 is connected with the pressure sink 15. Thus, the hydraulic steering unit 3 has a pressure relief connection to the pressure sink 15 via the working connections L, R, the steering valve 5 and the control element 16. The control element 16 has a two/two-way valve 13c, which is connected with the pump 6 via a control pressure line 29c. Instead of the two/two-way valve 13c, an indirectly operated non-return valve can also be used. During normal operation of the pump 6, the pump pressure, which acts upon the two/two-way valve 13c as control pressure, is sufficient to connect the two/two-way valve 13c against the spring force of the spring 14c in such a way that the control element 16 is penetrable. Thus, excess pressure from the hydraulic steering unit 3 can be supplied to the pressure sink 15. In case that the pump 6 cannot supply a sufficient pump pressure, the spring force of the spring 14c is larger than the control pressure, which acts upon the two/two-way valve 13c. In this position, the control element 16 is closed. Thus, no pressure from the hydraulic steering unit can be supplied to the pressure sink 15. In connection with an emergency steering the total pressure, which is available at the hydraulic steering unit 3 is thus passed on to the steering motor 4 via the emergency steering path 8.

1. Method for emergency steering of a hydraulic steering arrangement with a steering handwheel, in which a steering valve is optionally operated via the steering handwheel or via a control pressure generator, and a steering motor is acted upon by a pump pressure of a pump via the steering valve, characterised in that the steering motor is connected with a hydraulic steering unit via an emergency steering path, when the pump pressure drops below a first threshold value.

2. Method according to claim 1, characterised in that a pressure relief connection coming from the hydraulic steering unit is blocked when the pump pressure drops below a second predetermined threshold value.

3. Hydraulic steering arrangement with a steering handwheel, which is connected with a hydraulic steering unit with two working connections and has a steering motor, which is connected with a pump via a steering valve, the steering valve being operable by the hydraulic pressure supplied optionally by a steering handwheel or by a control pressure generator, characterised in that an emergency steering path (8) with a control unit (9) is arranged between the steering motor (4) and the hydraulic steering unit (3), the control unit (9) being operable via a pump connection (P) of the hydraulic steering unit.

4. Steering arrangement according to claim 3, characterised in that the emergency steering path (8) has two short-circuiting connection lines (10a, 10b), that is, one between each of the working connections (L, R) of the hydraulic steering unit (3) and a cylinder side (11a, 11b) of a steering cylinder (12) of the steering motor (4).

5. Steering arrangement according to claim 3 or 4, characterised in that the control unit (9) has a two/two-way valve (13a, 13b) in each short-circuiting connection line (10a, 10b).

6. Steering arrangement according to one of the claims 3 to 5, characterised in that the two/two-way valves (13a, 13b) of the short-circuiting connection lines (10a, 10b) are penetrable, when a pump pressure of the pump, which acts upon the two two/two-way valves (13a, 13b) via the pump connection (P) as adjustment pressure, drops below a predetermined first threshold value.

7. Steering arrangement according to claim 3, characterised in that in connection with steering during normal operation the pump connection (P) has a pressure relief connection to a pressure sink (15).

8. Steering arrangement according to claim 7, characterised in that the pressure relief connection has a control element (16), which can be activated by the pump pressure.

9. Steering arrangement according to claim 8, characterised in that the control element (16) has a two/two-way valve (13c).

10. Steering arrangement according to one of the claims 7 to 9, characterised in that the two/two-way valve (13c) of the pressure relief connection is blocked, when the pump pressure of the pump (6), which acts upon the two/two-way valve (13c) as adjustment pressure, drops below a predetermined second threshold value.

11. Steering arrangement according to one of the claims 3 to 10, characterised in that each of the two/two-way valves (13a, 13b, 13c) has a spring (14a, 14b, 14c) with a predetermined spring force, which counteracts the actual adjustment pressure.

12. Steering arrangement according to one of the claims 3 to 11, characterised in that the two predetermined threshold values are approximately equally high.
